(19) United States
(12) Patent Application Publication
(10) Pub. No.: US 2024/0362528 A1
(43) Pub. Date: Oct. 31, 2024

(54) TRANSFER LEARNING USING TREES

(71) Applicant: Intuit Inc., Mountain View, CA (US)

(72) Inventor: Itay Margolin, Petach Tikva (IL)

(73) Assignee: Intuit Inc., Mountain View, CA (US)

(21) Appl. No.: 18/307,550

(22) Filed: Apr. 26, 2023

(51) Int. Cl. G06N 20/00

(52) U.S. Cl. CPC G06N 20/00

(57) ABSTRACT

A system is configured to train a machine learning tree network using path based features, such as leaf nodes or connections between nodes. A first machine learning tree network model, for example, may be trained using a first set of training data, and used to generate predictions for a second set of training data. The path based features are determined from the first machine learning tree network model when generating the predictions for the second set of training data. The path based features may then be used to train a second machine learning tree network model, e.g., using logistic regression.

### TECHNICAL FIELD

This disclosure relates generally to machine learning models, and in particular to techniques and systems for training machine learning models.

### DESCRIPTION OF RELATED ART

Machine learning is a form of artificial intelligence that uses algorithms to use historical data as input to predict new output values. Machine learning, for example, may be used in a wide variety of tasks, including natural language processing, financial analysis, image processing, generating recommendations, spam filtering, fraud detection, malware threat detection, business process automation (BPA), etc. In general, machine learning uses training examples to train a model to map inputs to outputs. Once trained, a machine learning model may be used to accurately predict outcomes from new, previously unseen data.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable features disclosed herein.

One innovative aspect of the subject matter described in this disclosure can be implemented as a computer-implemented method for training a machine learning tree network model. An example method includes obtaining a first set of training data and a second set of training data and producing a first trained machine learning tree network model based on the first set of training data. The method includes determining path based features produced by the first trained machine learning tree network model when the first trained machine learning tree network model generates predictions for the second set of training data. The method produces a second trained machine learning tree network model for the second set of training data based on the path based features produced by the first trained machine learning tree network model.

Another innovative aspect of the subject matter described in this disclosure can be implemented as a system for training a machine learning tree network model. The system includes one or more processors, and a memory coupled to the one or more processors and storing instructions that, when executed by the one or more processors, cause the system to perform operations. The operations performed by the system include obtaining a first set of training data and a second set of training data and producing a first trained machine learning tree network model based on the first set of training data. The operations performed by the system further include determining path based features produced by the first trained machine learning tree network model when the first trained machine learning tree network model generates predictions for the second set of training data. The operations performed by the system further include producing a second trained machine learning tree network model for the second set of training data based on the path based features produced by the first trained machine learning tree network model.

Another innovative aspect of the subject matter described in this disclosure can be implemented as a system for training a machine learning tree network model. An example system includes an interface configured to obtain a first set of training data and a second set of training data. The system further includes a model training module configured to produce a first trained machine learning tree network model based on the first set of training data. The system further includes a path based feature extraction module configured to determine path based features produced by the first trained machine learning tree network model when the first trained machine learning tree network model generates predictions for the second set of training data. The model training module is further configured to produce a second trained machine learning tree network model for the second set of training data based on the path based features produced by the first trained machine learning tree network model.

### BRIEF DESCRIPTION OF THE DRAWINGS

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

FIG. 1 illustrates a block diagram of a system configured for training a machine learning tree network model, according to some implementations.

FIG. 2 illustrates data sets for a first task and a second task for training a machine learning tree network model.

FIG. 3 illustrates training a machine learning tree network model with a data set for a first task.

FIG. 4 illustrates extracting path based features from the machine learning tree network model trained the data set for the first task when generating predictions for the data set for the second task.

FIGS. 5A and 5B illustrate a graph and chart showing possible path based features in the machine learning tree network model when generating predictions for the data set for the second task.

FIG. 6 illustrates producing of a machine learning tree network model for the second task based on the extracted path based features.

FIG. 7 illustrates a flowchart depicting an example operation for training a machine learning tree network model, according to some implementations.

Like reference numbers and designations in the various drawings indicate like elements.

### DETAILED DESCRIPTION

The following description is directed to certain implementations for training machine learning tree network models, such as decision trees, Random Forest, Gradient boosted trees, etc., for a task using information derived from a larger task. The machine learning tree network model, for example, may be trained on a larger task, and used to generate path based features when used to generate predictions for the smaller task. The path based features may then be used to train the machine learning tree network model for the second, smaller, task, e.g., using logistic regression. It may be readily understood that certain aspects of the disclosed systems and methods can be arranged and combined in a wide variety of different configurations, applications, and use cases, all of which are contemplated herein.

Machine learning is a type of artificial intelligence that uses techniques from statistics to create algorithms that can trained using empirical data to make classifications and predictions in various domains such as natural language processing, credit and financial stability, fraud and risk detection, computer vision tasks, human health diagnosis, etc. Machine learning based systems typically use large training data sets to generate a model that will respond accurately to new data sets. To produce an accurate model, it is generally desirable to use a large and accurate training data set.

Creating new training data sets for each task, however, may be difficult and expensive. Transfer learning is sometimes used to assist in training machine learning models. Transfer learning is used to extract knowledge from one or more source tasks, and to apply that knowledge to a target task. By exploiting the knowledge extracted from the source tasks it is possible to improve the generalization of the classifier in the target task.

Transfer learning, however, is not suitable for all types of machine learning models and tasks. For example, transfer learning is typically considered impractical for use with tree-based models. Nevertheless, it may be desirable to leverage the knowledge derived from training from a first task, i.e., a source task to improve the leaning of a separate (but similar) target task, particularly if the target task is little data and may be difficult to accurately train a machine learning model.

As discussed herein, machine learning tree network models are trained using, e.g., logistic regression, so that path based features, such as decision paths in the decision trees trained from a larger task propagate to the smaller task. For example, in some implementations, The first task (larger source task) is used to train a tree-based model, such as Random Forest, Gradient boosted trees, etc. The trained tree-based model is then used to generate predictions to elements from the second task (smaller target task). Rather than using the resulting predictions from the trained tree-based model for the second task, path based features from the trained tree-based model that led to the predictions, such as the decision paths, are obtained and used to form new features for the second task. The tree-based model may then be trained for the second task using the path based features. Because the path based features already captured the interaction between the raw features, there is no need to train a sophisticated model on top of them, and linear or logistic regression may be used. Thus, the new model is formed by using the trained tree-based model for the first task to transform the raw features of the second task into binary, path based features, and linear or logistic regression is used with the path based features to produce the tree-based model trained for the second task.

In the following description, numerous specific details are set forth such as examples of specific components, circuits, and processes to provide a thorough understanding of the present disclosure. The term “coupled” as used herein means connected directly to or connected through one or more intervening components or circuits. The terms “processing system” and “processing device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example implementations. In other instances, well-known circuits and devices are shown in block diagram form to avoid obscuring the present disclosure. Some portions of the detailed descriptions which follow are presented in terms of procedures, logic blocks, processing, and other symbolic representations of operations on data bits within a computer memory.

In the figures, a single block may be described as performing a function or functions. However, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example systems and devices may include components other than those shown, including well-known components such as a processor, memory, and the like.

Several aspects of training tree-based models will now be presented with reference to various apparatus and methods. These apparatus and methods will be described in the following detailed description and illustrated in the accompanying drawings by various blocks, components, circuits, devices, processes, algorithms, and the like (collectively referred to herein as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

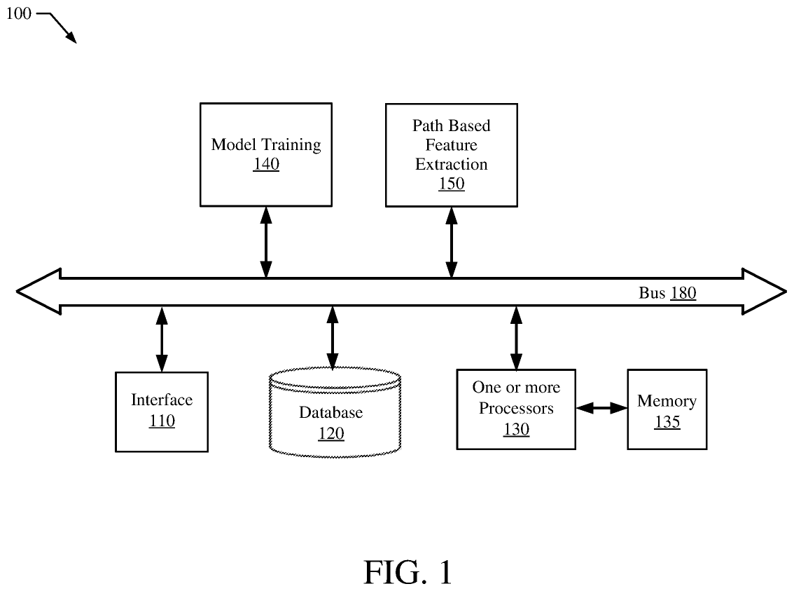

FIG. 1 shows a block diagram of a system 100 configured for training a machine learning tree network model, according to some implementations. The system 100 is shown to include an input/output (I/O) interface 110, a database 120, one or more processors 130, a memory 135 coupled to the one or more processors 130, a model training module 140, a path based feature extraction module 150, and a data bus 180. The various components of the system 100 may be connected to one another by the data bus 180, as depicted in the example of FIG. 1. In other implementations, the various components of the system 100 may be connected to one another using other suitable signal routing resources.

The interface 110 may include any suitable devices or components to obtain information, e.g., input data such as training data sets, for the system 100 and/or to provide information, e.g., output data such a trained model in a computer-readable format, from the system 100. In some instances, the interface 110 may include a display and an input device (such as a mouse and keyboard) that allows a person to interface with the system 100 in a convenient manner. For example, the interface 110 may be used to obtain a first set of training data and a second set of training data, which may be stored in the database 120, and may be processed by the model training module and path based feature extraction module 150, as discussed herein. Additionally or alternatively, the interface 110 may include an ethernet port, wireless interface, or other means to communicate with one or more other devices via wires or wirelessly. In some implementations, the system 100 may host an application for making classifications and predictions based on input data in various domains such as natural language processing, credit and financial stability, fraud and risk detection, computer vision tasks, human health diagnosis, etc., using models trained, as discussed herein.

The model training module 140 and the path based feature extraction module 150 may be implemented as one or more special purpose processors, which may be implemented separately or as part of the one or more processors 130. For example, the model training module 140 and the path based feature extraction module 150 are illustrated separately from the one or more processors 130 for clarity, but in some implementations, the one or more processors 130 may execute instructions stored in memory 135, which configure the one or more processors 130 to perform one or more functions described herein. In the context of this particular specification, the one or more processors 130 may be a general purpose computer that once programmed pursuant to instructions stored in memory operates as a special purpose computer to perform one or more functions of the model training module 140 and the path based feature extraction module 150, described herein.

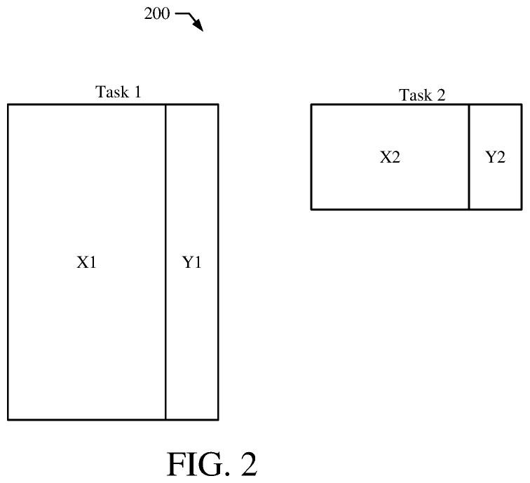

FIG. 2, by way of example, illustrates two different training tasks 200, i.e., task 1 and task 2, for training a machine learning model, such as a tree network. The tasks, i.e., task 1 and task 2 may be stored in the system 100, e.g., in database 120 and/or memory 135.

Task 1 includes a large amount of labeled data, e.g., including X1, representing features (columns) of a number of samples (rows), and Y1, representing e.g., class labels, dependent variables or output variables, with which a machine learning model may be easily trained. Task 2, on the other hand, has less labeled data that task 1, including X2, representing features (columns) of a number of samples (rows), and Y1, representing e.g., class labels, dependent variables or output variables. Task 2, for example, may include the same set of features, but may have fewer samples, than task 1. The training of a machine learning model with task 2, for example, may be more difficult and/or less accurate due to the sparsity of training data. The tasks 1 and task 2 data sets may be tabular data or other types of data.

Task 2 may have the same set of features as task 1, and accordingly, transfer learning may sometimes be used for training a machine learning model for task 2, e.g., for deep learning neural networks. Deep learning neural networks, however, are not appropriate for certain kinds of data, such as tabular data, transfer learning is generally not suitable for these kinds of data. Tree-based models are more suitable for such data, but transfer learning for tree-based models, however, is considered impractical. Nevertheless, it may be desirable to leverage the knowledge derived from the source task, e.g., task 1, to improve the leaning of a separate (but similar) target task, e.g., task 2.

As discussed herein, a model may be trained using tree-based model trained for task 1 to transform the raw features of the task 2 into binary, path based features, and using linear or logistic regression with the path based features to produce the tree-based model trained for task 2. For example, a tree-based model (e.g., Random Forest, Gradient boosted trees) may be trained using task 1.

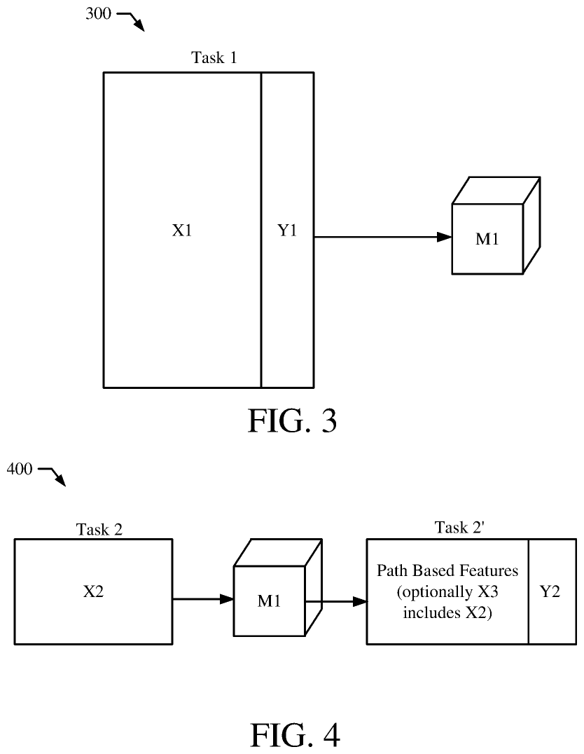

FIG. 3, by way of example, illustrates training 300 of a machine learning model using the task 1 data set, e.g., to produce model M1. Supervised training may be used to produce tree-based model M1 that establishes the relationship between input X1 and output Y1 variables. The tree-based model M1 may perform regression or classification. The model training to produce M1, for example, may be implemented by the system 100 using model training module 140 and database 120. It is to be understood that the training 300 may be performed by other suitable systems, computers, or servers.

The model M1, for example, may be trained using any desired training algorithm. In some implementations, the model M1 includes a decision forest, i.e., a number of trees, each of which is trained, and each tree may be independently trained based on the task 1 data set, with a level of randomness introduced into the training process in order to de-correlate individual tree predictions and improve generalization. In some implementations, the training algorithm, by way of example, may follow a top-down approach, optimizing the parameters of the root node in the beginning and recursively processing child nodes. The recursion may be stopped when all the items in the training set have the same labels, or a maximum depth of the tree is reached, or the number of points reaching the node is below a minimum number of allowed points.

FIG. 4 illustrates extracting path based features 400 by generating predictions for task 2 data using model M1. The path based feature extraction, for example, may be implemented by the system 100 using path based feature extraction module 150 and database 120. It is to be understood that the extraction of path based features may be performed by other suitable systems, computers, or servers.

Once the model M1 is trained based on the task 1 data, e.g., as illustrated in FIG. 3, the model M1 is used to generate predictions for elements in the task 2, shown in FIG. 2. Path based features are determined from the model M1 when it generates predictions from the task 2 data, which may be stored as a modified task 2 data set (task 2′), which includes X3 representing the path based features for a number of samples, and Y2 representing the class labels, dependent variables or output variables associated with the samples. In some implementations, the task 2′ data may additionally include features from the task 2 data.

The path based features determined from the model M1 when generating predictions from the task 2 data are not the resulting predictions, but instead are features related to the path taken through the model M1 to generate the predictions. For example, the path based features may be nodes in the model M1 (including leaf nodes), connections between nodes or a combination thereof, used by the model M1 when generating predictions for the task 2 data.

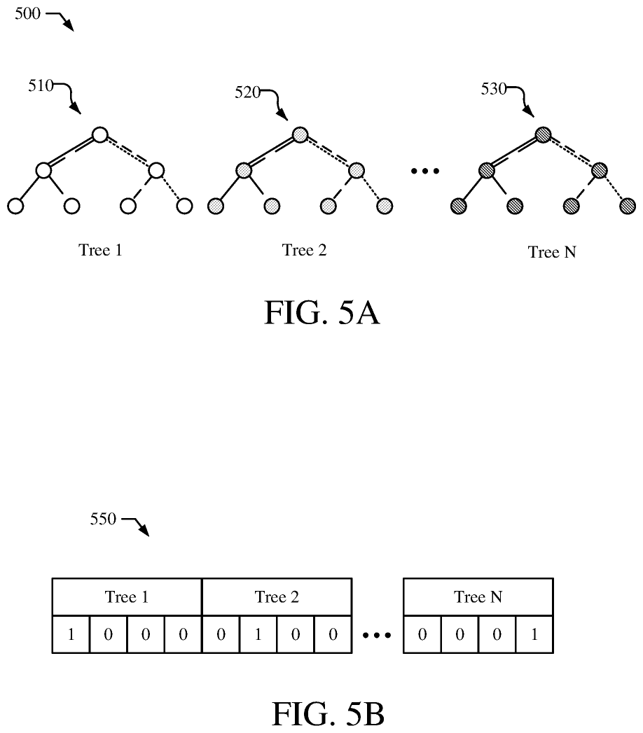

FIGS. 5A and 5B, for example, illustrate a graph 500 and chart 550, respectively, showing possible path based features in a model M1 when generating predictions for the task 2 data.

The graph 500, for example, may be for model M1, which may include a plurality of decision trees tree 1, tree 2, . . . tree N, which are respectively illustrated as decision tree structures 510, 520, and 530. The decision tree structures 510, 520, and 530 each include a number of nodes, including a root node, which has no parent, and a number of leaf nodes, which have no children, and connections, i.e., paths, between the nodes. The various possible paths that may be taken through each decision tree structure 510, 520, and 530 are illustrated with a solid line, a long dashed line, a short dashed line, and a dotted line. The path based features determined from the model M1 when generating predictions for the task 2 data may include the nodes in the model M1, such as leaf nodes, the connections between nodes, or a combination thereof.

It should be understood that decision tree structures 510, 520, and 530 may be more complicated than illustrated in FIG. 5A and, for example, may include a different number of nodes, the nodes may be binary or non-binary, and the decision tree structures 510, 520, and 530 may differ from each other. It should be further understood that when generating predictions for task 2 data, different paths or nodes may be used in each of the decision tree structures 510, 520, and 530. When generating a prediction for task data, an ensemble model may use predictions from a plurality of trees. Model M1, for example, when generating a prediction for the task 2 data, may use the predictions from each of the plurality of decision trees, tree 1, tree 2, . . . tree N. For classification, the output of the model M1, for example, may be the class selected by the majority of the decision trees. For regression, the output of the model M1 may be a mean or average prediction from the individual decision trees. The path based features may further include information related to the decision trees used for generating the predictions by model M1 for the task 2 data. For example, for classification, the path based features may further include decision tree members of the majority. For regression, the path based features may further include decision trees that are within a predesignated threshold from the mean or average prediction, e.g., within a standard deviation.

FIG. 5B, by way of example, illustrates a chart 550 that identifies the path based features for the model M1 when generating predictions for the task 2 data, including a binary indication of whether the path based feature was used, e.g., passed through, for each of the decision trees, e.g., tree 1, tree 2, . . . tree N. In chart 550, the path based feature may be the leaf nodes for each decision tree, which are labeled with a 0 or 1 to indicate whether the decision path includes the leaf node. In other implementations, however, the path based feature may be connections between nodes, which similarly may be labelled with a 0 or 1 to indicate whether the decision path includes the connection.

As the path based information, e.g., nodes and/or connections between nodes, are captured by the interaction between the raw features of X2 in the task 2 data and the model M1, there may be no need to train separate model for the task 2 data. Instead, the path based features captured in task 2′ (shown in FIG. 4), may be used to produce the model for the task 2 data, e.g., using linear or logistic regression.

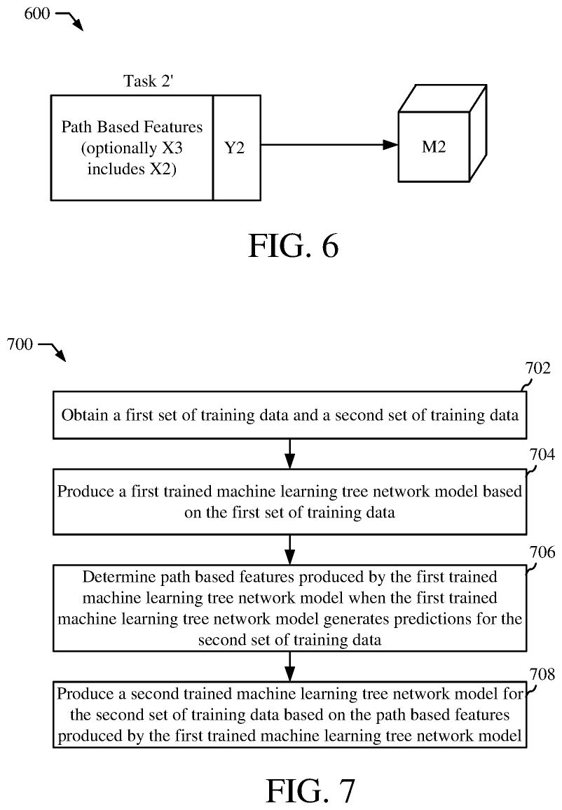

FIG. 6, by way of example, illustrates producing 600 of a machine learning model using the task 2′ data set, including the path based features produced by model M1 for generating predictions for the task 2 data set, to produce model M2. The production of model M2, for example, may be implemented by the system 100 using model training module 140 and database 120. It is to be understood that the model M2 may be produced by other suitable systems, computers, or servers.

The model M2, for example, may be produced using regression analysis, such as linear regression or logistic regression. Linear regression, which may be simple linear regression or multiple linear regression, for example, is based on a linear relationship that is present between the features (e.g., X3) and the dependent variables Y2, and may be determined by finding the best fitting line or plane that describes two or more variables. Logistic regression, is a classification algorithm that is used to classify elements of a set into two groups by calculating the probability of each element of the set. Logistic regression, for example, may be used when the dependent variable has a binary solution, e.g., as in the path based features.

To avoid overfitting, regularization may be used during the linear or logistic regression to produce model M2. For example, in model M1 when predicting the output for task 2 data, each tree may receive a score of the attribution that it added to the ensemble model. The inverted version of the attribution score may be used for regularization. Accordingly, the second model M2 will use trees that have a high attribution, as opposed to trees with low attribution.

Thus, a two stage solution is used to generate the model M2 for the task 2 data set. The initial model M1 is used to transform the raw features from the task 2 data set into path based features, and the path based features are used, e.g., in logistic regression (or linear regression) to produce the model M2.

FIG. 7 illustrates another example process flow 700 for training a machine learning tree network model, according to some implementations. The process flow 700, for example, may be a computer-implemented method implemented by the system 100 using model training module 140, the path based feature extraction module 150, and database 120. It is to be understood that the process flow 700 may be performed by other suitable systems, computers, or servers.

As illustrated, at block 702, a first set of training data and a second set of training data is obtained, e.g., as discussed in reference to task 1 and task 2 data sets in FIG. 2. The first set of training data and a second set of training data may be obtained, e.g., from database 120 or memory 135 in system 100. In some implementations, the first set of training data and the second set of training data may include tabular data. In some implementations, for example, the second set of training data may have fewer features than the first set of training data.

At block 704, a first trained machine learning tree network model is determined based on the first set of training data, e.g., as discussed in reference to FIG. 3. The machine learning tree network model, for example, may be a decision tee ensemble, such as Random Forest Gradient boosted trees, which may be configured for classification or regression.

At block 706, the process determines path based features produced by the first trained machine learning tree network model when the first trained machine learning tree network model generates predictions for the second set of training data, e.g., as discussed in reference to FIGS. 4, 5A, and 5B. The path based features may include at leaf nodes, connections between nodes, or a combination thereof, that are used by the first trained machine learning tree network model to generate predictions for the second set of training data. The path based features may further include information, such as the attribution score, related to the decision trees used for generating the predictions by the first trained machine learning tree network model. In some implementations, the path based features may be determined for features in the second set of training data that are present in the first set of training data.

At block 708, a second trained machine learning tree network model is produced for the second set of training data based on the path based features produced by the first trained machine learning tree network model, e.g., as discussed in reference to FIG. 6. In some implementations, the second trained machine learning tree network model may be a logistic regression model. In some implementations, the second trained machine learning tree network model is produced by performing regularization of the second trained machine learning tree network model, for example, based on attribution scores associated with decision trees in the first trained machine learning tree network model. Additionally, in some implementations, the second trained machine learning tree network model may be produced further based on at least a portion of the second set of training data.

As used herein, a phrase referring to “at least one of” a list of items refers to any combination of those items, including single members. As an example, “at least one of: a, b, or c” is intended to cover: a, b, c, a-b, a-c, b-c, and a-b-c.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The various illustrative logics, logical blocks, modules, circuits, and algorithm processes described in connection with the implementations disclosed herein may be implemented as electronic hardware, computer software, or combinations of both. The interchangeability of hardware and software has been described generally in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor or any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

1. A computer-implemented method for training a machine learning tree network model, comprising:
collecting a first set of training data and a second set of training data from a database;
training a first machine learning tree network model using the first set of training data to produce a first trained machine learning tree network model;
generating predictions with the first trained machine learning tree network model for the second set of training data;
determining a set of path based features comprising at least one of leaf nodes and connections between nodes of the first trained machine learning tree network model when generating the predictions for the second set of training data; and
training a second machine learning tree network model using the set of path based features comprising the at least one of leaf nodes and connections between nodes of the first trained machine learning tree network model to produce a second trained machine learning tree network model for the second set of training data.

2. (canceled)

3. The computer-implemented method of claim 1, wherein the first set of training data and the second set of training data comprise tabular data.

4. The computer-implemented method of claim 1, wherein the second set of training data has fewer features than the first set of training data.

5. The computer-implemented method of claim 1, wherein the path based features comprising the at least one of leaf nodes and connections between nodes are determined for features in the second set of training data that are present in the first set of training data.

6. The computer-implemented method of claim 1, wherein the second trained machine learning tree network model comprises a logistic regression model.

7. The computer-implemented method of claim 1, wherein training the second machine learning tree network model comprises performing regularization of the second machine learning tree network model.

8. The computer-implemented method of claim 1, wherein training the second machine learning tree network model further uses at least a portion of the second set of training data.

9. A system for training a machine learning tree network model, comprising:
one or more processors; and
a memory coupled to the one or more processors and storing instructions that, when executed by the one or more processors, cause the system to perform operations comprising:
collecting a first set of training data and a second set of training data;
training a first machine learning tree network model using the first set of training data from a database to produce a first trained machine learning tree network model;
generate predictions with the first trained machine learning tree network model for the second set of training data;
determine a set of path based features comprising at least one of leaf nodes and connections between nodes of the first trained machine learning tree network model when generating the predictions for the second set of training data; and
training a second machine learning tree network model using the set of path based features comprising the at least one of leaf nodes and connections between nodes of the first trained machine learning tree network model to produce a second trained machine learning tree network model for the second set of training data.

10. (canceled)

11. The system of claim 9, wherein the first set of training data and the second set of training data comprise tabular data.

12. The system of claim 9, wherein the second set of training data has fewer features than the first set of training data.

13. The system of claim 9, wherein the path based features comprising the at least one of leaf nodes and connections between nodes are determined for features in the second set of training data that are present in the first set of training data.

14. The system of claim 9, wherein the second trained machine learning tree network model comprises a logistic regression model.

15. The system of claim 9, wherein the system is caused to perform training the second machine learning tree network model by performing regularization of the second machine learning tree network model.

16. The system of claim 9, wherein the system is caused to perform training the second machine learning tree network model further uses at least a portion of the second set of training data.

17. A system for training a machine learning tree network model, comprising:
an interface configured to collect a first set of training data and a second set of training data from a database;
a model training module configured to train a first machine learning tree network model using the first set of training data to produce a first trained machine learning tree network model; and
a path based feature extraction module configured to generate predictions with the first trained machine learning tree network model for the second set of training data, and determine a set of path based features comprising at least one of leaf nodes and connections between nodes of the first trained machine learning tree network model when generating the predictions for the second set of training data;
wherein the model training module is further configured to train a second machine learning tree network model using the set of path based features comprising the at least one of leaf nodes and connections between nodes of the first trained machine learning tree network model to produce a second trained machine learning tree network model for the second set of training data.

18. (canceled)

19. The system of claim 17, wherein the model training module is configured to produce the second trained machine learning tree network model using logistic regression.

20. The system of claim 17, wherein the model training module is configured to train the second machine learning tree network model using regularization of the second machine learning tree network model.
